(19) United States
(12) Patent Application Publication
(10) Pub. No.: US 2006/0260416 A1
(43) Pub. Date: Nov. 23, 2006

(54) Flow metering system

(76) Inventors: Burton H. Sage, Hot Springs Village, AR (US); Michael A. Klimowilz, Escondido, CA (US); Meghan Burns Simmons, Yuma, AZ (US)

Correspondence Address: BURTON SAGE, 2453 IMPALA DRIVE, CARLSBAD, CA, 92010, US

(21) Appl. No.: 11/131,942

(22) Filed: May 19, 2005

(51) Int. Cl. G01F 1/708

(52) U.S. Cl. 73/861.95

(57) ABSTRACT

A non-contact fluid flow monitor that enables a two component system comprised of a removable conduit and reusable flow rate sensor is described. The monitor is capable of measuring fluid flow velocity and the dimensions of the removable conduit thereby calculating a true volumetric flow rate. The monitor is further capable of determining the refractive index of the fluid thereby verifying that the fluid flowing through the conduit has this expected property.

### FIELD OF THE INVENTION

This invention relates to devices and methods for measuring fluid flow. More specifically, the invention relates to fluid delivery systems that introduce a thermal tracer into the fluid and monitor the progress of the thermal tracer by optically detecting the change of index of refraction inherent in the thermal tracer.

### BACKGROUND.

Devices and methods for measuring the flow of a fluid in a conduit using the thermal “time of flight” method are known. Such flow sensors are useful in measuring fluid flow in analytical systems such as high performance liquid chromatography (HPLC) systems, in drug delivery systems, and other systems such as fluid mixing systems where accurate knowledge of the quantity of fluid being delivered to a delivery site is needed. Jerman et al in U.S. Pat. No. 5,533,412 teach an integrated thermal time of flight device on a substrate where elements to introduce a thermal tracer into the flowing stream using thermal elements are in contact with the conduit along which the stream flows. Others, including Sobek et al in application publication US 20050066747, teach devices where the elements to introduce the thermal marker and to detect the thermal marker are in contact with the fluid. Bornhop in U.S. Pat. No. 6,381,025 and Yin et al in U.S. Pat. No. 6,386,050 teach a non contact system where an optical probe is used to detect the passage of the thermal marker based on the motion of an interference pattern caused by changes in the index of refraction inherent in the thermal marker. Sage, in application Ser. No. 10/786,562 teaches a second non contact system that uses radiant energy to introduce a thermal marker into the flowing stream but uses an optical probe to detect the passage of the thermal marker based on diffraction of the probing optical beam caused by changes in the index of refraction inherent in the thermal marker.

Thermal time of flight methods that are not physically isolated from the fluid flow rely on the thermal conductivity of the probes to create both the thermal marker and to detect the passage of the thermal marker. Such systems are inherently relatively slow since the flow of thermal energy is not a rapid phenomenon. The measured time of flight in such systems is seldom less than a few tens of milliseconds.

The optical probes described by Bornhop, Yin et al, and Sage overcome this problem. The measured time of flight can be as short as 100 microseconds and the resolution of the time of flight can be as short as 1 microsecond. However, to achieve this level of performance, relatively sophisticated and expensive lasers should be used.

Further, in all of these non-contact flow measurement teachings, only the velocity of the flowing stream is measured. Measurement of a true volumetric flow rate additionally requires the cross sectional area of the conduit. This is especially important in a conduit of circular cross section where the volumetric flow depends on the diameter of the conduit to the fourth power. In a fluid delivery system that is to be used over a wide temperature range, the dimensions of the conduit will change due to thermal expansion. In a fluid delivery system where the conduit is disposable and replaced frequently, the dimensions of the new conduit will be unknown. Thus there is a need for improved flow sensors, especially a system that measures geometrical changes of the flow channel as well as the velocity of the flow stream.

### SUMMARY OF THE INVENTION

An apparatus and method for accurately measuring volumetric flow of a liquid along a conduit is described. Bornhop in U.S. Pat. No. 6,381,025 and Yin, et al in U.S. Pat. No. 6,386,050 describe an interferometric method of measuring index of refraction changes in a liquid flowing along a conduit and the use of this method to measure the index of refraction of the liquid and the velocity of the liquid flowing along the conduit. These devices and methods have the distinct advantage that the flow of the fluid may be monitored without contact with either the fluid or the conduit within which the fluid is flowing. This invention expands the teachings of Bornhop and Yin et al in several important ways. First, it teaches that interference is not necessary in order to measure the refractive index or the liquid velocity as described. Thus, a light source with sufficient coherence to establish an interference patterns is not required. Although a laser may be used, virtually any light source with sufficient intensity to activate the detectors may be used.

Second, while Bornhop and Yin et al realize the value of their non-contact interferometric methods in maintaining a contamination free conduit and in eliminating the thermal effects of contact based thermal time of flight systems, they have not realized the further advantage of being able to use a removable and disposable conduit that mates with the heat source and interferometric flow sensor. Such a removable and disposable conduit has the advantage of providing a two-part system, such as a drug delivery system or an analyzer such as an HPLC that does not requiring cleaning between uses, thereby providing enhanced user convenience and overall lower cost.

Third, the methods of Bornhop and Yin et al do not accommodate variations in the cross-sectional area of the flow tube. In a system where the conduit is not disposable, the system may be calibrated to accommodate the cross sectional area such that the measured time of flight corresponds to a true volumetric flow rate. In a system with a disposable conduit, this process will not provide an accurate flow rate. When a new conduit is mated to the heat source and flow sensor the cross sectional area of the new conduit will be different than the cross sectional area of the previous one due to manufacturing tolerances. Further, in a fluid delivery system where the conduit is not disposable and is used over a wide temperature range, thermal expansion will cause the dimensions of the conduit to change. These differences, although typically small, are critically important because the volumetric flow rate varies with the fourth power of the conduit dimension. Hence any calibration that may have been done with an earlier conduit will not be appropriate for the new conduit. And a calibration performed at one temperature will not be appropriate for other temperatures. Nothing in the teachings of Yin et al and Bornhop teach measurement of the cross sectional area of the conduit when the conduit is in use to provide a true volumetric flow rate. It is noteworthy that a dimension of the conduit can be obtained directly from the interference pattern of Bornhop and Yin et al, or the refraction pattern of this invention. Bornhop and Yin et al teach that the liquid velocity may be measured by the motion of the interference pattern due to the transit of a thermal market. This invention notes that a dimension of the conduit may be obtained from measurements of the interference pattern. For example, the height of a rectangular conduit may be calculated from the spacing of the maxima of the pattern. In the case of a rectangular conduit, a second orthogonal sensor may be used to obtain the orthogonal dimension of the conduit, but in the case where even a square conduit is manufactured by injection molding, since a primary variance from conduit to conduit is variation in shrinkage as the conduit cools, a single measurement of a dimension of the conduit may provide sufficient compensation to achieve the desired level of accuracy of flow measurement. From a practical point of view, the measurement of the dimension of the conduit may be taken when the fluid in the conduit is air since the refractive index of air is low and the stability of the measurement is high. Such a practical matter is perhaps more important when the fluid that will eventually flow in the conduit is a liquid. Liquids in general have a relatively high variation of refractive index with temperature. Making the measurement of the conduit dimension when there is no liquid in the conduit, such as before an IV infusion set is primed for delivery of the therapeutic solution, avoids the issue of the temperature dependence of the refractive index of the liquid. One could also provide a temperature sensor and data related to the temperature dependence of the refractive index of the liquid to overcome this problem.

When the measurement of the conduit dimension is made with no liquid in the conduit, the location of the maxima and minima of the reflection pattern may also be noted as well as the separation of the maxima or minima. When the liquid to be delivered is added to the conduit such that the liquid flows through the interrogation region, the reflection pattern will be shifted to a new position. The magnitude of this shift is directly proportional to the refractive index of the liquid. Note that no thermal marker has been added to the liquid to make this measurement. In this way, the refractive index of the liquid may be determined. With knowledge of the temperature and the dependence of the various liquid that may flow in the conduit, the identity of the liquid may be determined.

Fourth, both Bornhop and Yin et al teach the determination of velocity as the ratio of the distance from the point of placing the thermal marker in the stream to the point of detection of the thermal marker and the measured elapsed time between placing the thermal marker in the stream and detecting the thermal marker. Yin et al fuel teach that the thermal marker may be time dependent, for example sinusoidal such that the phase difference between the thermally introduced sinusoid and the detected sinusoid can be used to determine the stream velocity. In each of these teachings, the time required to place the thermal marker in the stream introduces an uncertainty in the measurement of the time of flight and hence the stream velocity. In one embodiment of this invention, this uncertainty is overcome by noting that if the thermal marker is introduced quickly such that its length in the conduit is short compared to the spacing of the pattern, the elapsed time between the passing of the thermal marker through each of the beams provides a time of flight independent of the nature of introduction of the thermal marker. Further, since the thermal marker passes through all of the beams of the pattern, several independent measures of the time of flight may be made, which may be averaged to improve the precision of the measurement.

Fifth, both Yin et al and Bornhop are silent on the methods of calibration that may be needed to obtain accurate flow measurements over a useful range of flow rates. This invention teaches that the volumetric flow rate within a specific conduit is best described as a polynomial function of the measured “time of flight”, or the calculated velocity using the measured “time of flight”.

### BRIEF DESCRIPTION OF THE FIGURES

FIG. 1 shows the reflection pattern of light incident on a capillary.

FIG. 2 shows the deflection of a portion of the light pattern by a small thermal marker.

FIG. 3 shows the deflection of a light pattern by a time dependent thermal marker.

FIG. 4 shows a disposable conduit with a flow cell with a probing region.

FIG. 5 shows a disposable conduit mated with a fluid delivery system.

FIG. 6 shows a calibration curve of the flow monitoring system.

FIG. 7 demonstrates the time of flight detection for a small thermal marker.

FIG. 8 demonstrates the time of flight detection for a modulated thermal marker.

FIG. 9 shows the deflection of a light pattern with a fluid of different density.

### DETAILED DESCRIPTION

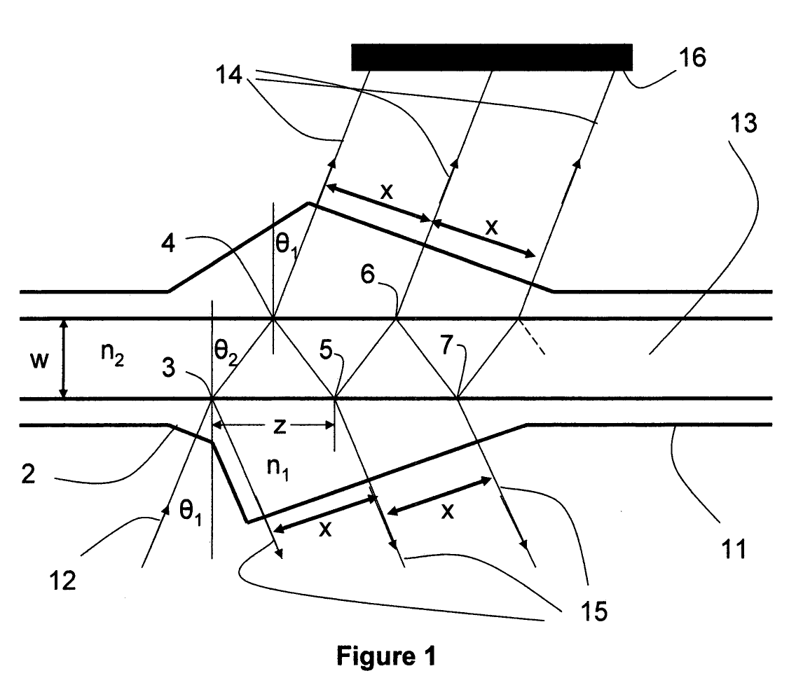

FIG. 1 shows the pattern of light resulting from a single incident beam 12 on a capillary in a first embodiment of the invention. Incident beam 12 may be generated by a laser, or by an LED, or a tungsten lamp, or any other source of light sufficiently strong to provide the needed signals from detector 16. Incident beam 12 enters conduit 11 through side wall 2. One angle of incidence that avoids unwanted reflection at side wall 2 is normal incidence as shown. Incident beam 12 continues unrefracted into and through the wall of conduit 11 until it enters the fluid stream at position 3. At position 3 a portion of light beam 12 is refracted and a portion is reflected when fluid 13 has a refractive index other than the refractive index (n₁) of the conduit 11. The reflected portion of incident beam 12 leaves the conduit as one of reflected beams 15. The refracted portion of incident beam 12 continues through fluid 13 until it reaches the opposite side of conduit 11 at position 4 where it is again a portion of incident beam 12 is refracted and a portion is reflected. The refracted portion of incident beam at position 4 continues through the opposite side of conduit 11 and leaves conduit 11 as one of transmitted beams 14. The reflected portion of incident beam 12 at position 4 returns to the proximal side of conduit 11 at location 5 where again a portion is reflected and a portion is refracted. The refracted portion leaves the proximal side of conduit 11 as a second of beams 15. The reflected portion returns to the distal side of conduit 11 at position 6 where again a portion is reflected and a portion is refracted. This process of reflection and refraction at the conduit fluid interface continues until all of the energy in the incident beam is consumed with the result that a series of light beams emerge from the conduit—a transmitted series of beams 14 and a reflected series of beams 15. This process of generating reflected beams 15 and transmitted beams 14 is based only on the geometry of the elements shown. The process in not dependent on the coherence of incident beam 12 or the phase of incident beam 12 and hence the process of interference is not responsible for the generation of the reflected and transmitted beams.

Conduit 11 may be glass or may be one of many common engineering plastics such as polyethylene or polypropylene. The main criteria for selecting the material for conduit 11 is that it is transparent to incident beam 12 and that it has smooth surfaces when formed. Conduit 11 also has raised surfaces in the area where incident beam 12 enters the conduit. As shown, these raised surfaces facilitate the exit of the reflected and refracted portions of incident beam 12.

As shown in FIG. 1, transmitted beams are incident on detector 16. Detector 16 constitutes a plurality of individual detecting elements and may be two or more individual detectors, a CCD line array detector or may be a multi-element imaging detector such as are common in electronic cameras today. Detector 16 is connected to a processor (not shown) for analyzing the pattern of light incident on detector 16. In particular, one of the properties of transmitted light pattern 14 that may be determined by the processor is the spacing of the various beams 14 denoted by X in FIG. 1. It is this spacing of the beams—detector 16 could be placed so that it captures either transmitted beams 14 or reflected beams 15 or both—and the motion of one or more of reflected beams 15 or transmitted beams 14 when a thermal marker passes through the beams that allows the system to monitor the flow of fluid 13 along conduit 11.

A first important parameter of conduit 11 that may be calculated from the patterns is the width W of conduit 11. If conduit 11 is circular in cross section, this measure would constitute the diameter of the conduit. If conduit 11 is rectangular in cross section, then W may represent either the width or the height of the cross section. A second similar optical system orthogonal to the one shown would determine the other dimension of a rectangular conduit. Since this measurement is made without touching conduit 11, this system may measure multiple conduits by simply placing the unknown conduit into the light beam as shown in FIG. 1. This non-contact method of measuring the inside dimensions of the conduit is useful when the conduit is disposable such as in drug delivery systems to avoid cleaning and transfer of body fluids from one person to another or in analytical systems again to avoid cleaning and to avoid contamination of future specimens.

Referring again to FIG. 1, incident beam 12 has an angle of incidence with the fluid 13 of θ₁ at location 3. By Snell's law, the angle of refraction θ₂ is given by
n₁ Sin θ₁=n₂ Sin θ₂
where n₁ is the index of refraction of the conduit and
n₂ is the index of refraction of the fluid.

By simple geometry
z=2w Tan θ₂

By further use of trigonometric identities, it can be shown that the width W of conduit 11 is related to the separation X of the various beams 14 as measured by detector array 16 in terms of the know parameters of conduit refractive index n₁, fluid refractive index n₂ and the angle of incidence θ₁ of light beam 12 in the following manner:
w=xn₂ [1−(n₁ Sin θ₁/n₂)²]^{1/2}/2n₁ Sin θ₁ Cos θ₁

In a round capillary where W is the diameter of the capillary, the volumetric flow rate would be equal to the product of the conduit cross sectional area A (A=Πw²) and the fluid velocity. In a square capillary, the volumetric flow rate would be the product of the cross sectional area A (A=w²) and the stream velocity. In a rectangular conduit, the volumetric flow rate would be the product of the cross sectional area A (A=w*h) and the stream velocity where h is the dimension of the rectangular conduit orthogonal to w, where h may be assumed to have the same relationship to the nominal value as the measured w has to its nominal value or h may be measured using a second optical system similar to the one shown in FIG. 1.

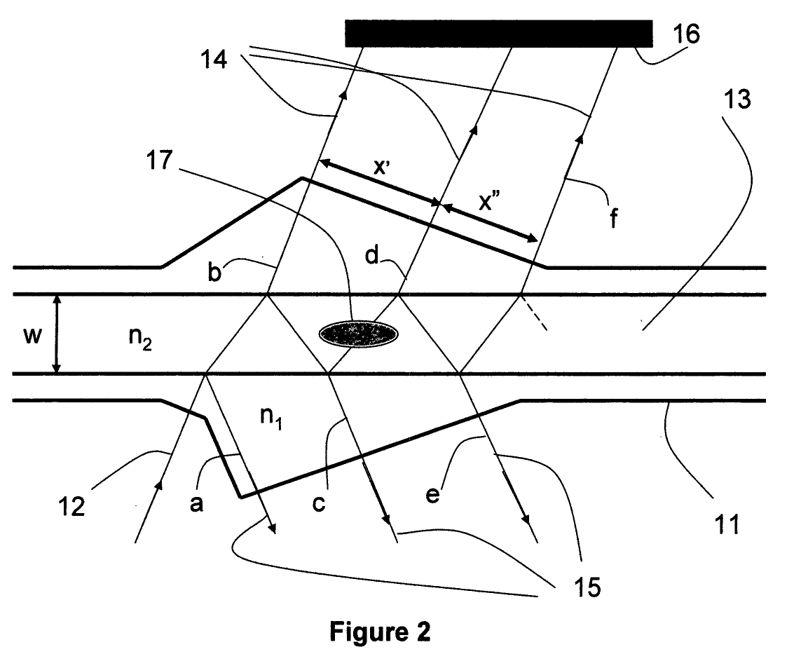

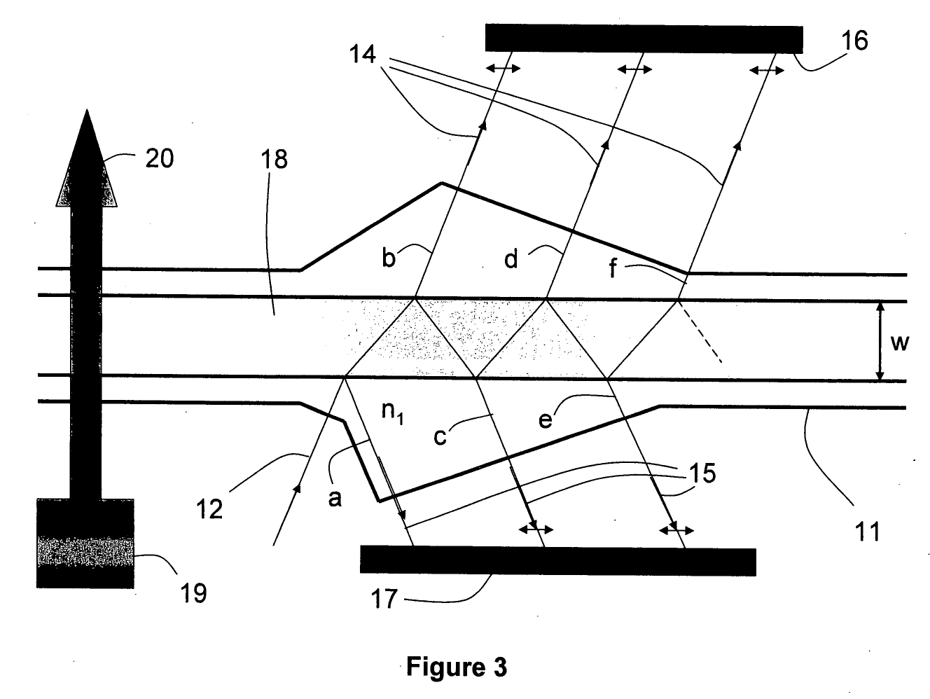

As noted above, the volumetric flow rate is the product of the cross sectional area of the conduit at the probing region times the velocity of the stream at the probing region. Using FIG. 1 and the above description, it is easy to see how the invention provides the cross sectional area of the conduit. The same optical configuration used to measure the conduit dimensions can be used to measure the velocity of the flowing fluid stream. There are at least two methods by which this can be done as shown in FIG. 2 and FIG. 3. In the first case, thermal marker 17 is shorter than the length of conduit 11 occupied by transmitted beams shown 14, denoted by beams b, d, and f in FIG. 2. In FIG. 2, thermal marker 17 has passed transmitted beam b and is now positioned to redirect transmitted beam d. As shown, since the heated fluid in the thermal marker is less dense than the surrounding cooler fluid, it will have a lower refractive index. Thus transmitted beam d will be refracted further from normal and the position of intersection with detector array 16 will move to the right, increasing the separation x′ between transmitted beam b and transmitted beam d. Similarly, since thermal marker 17 has not yet reached transmitted beam f, the distance x” between transmitted beam d and transmitted beam f will be shortened. Detector array 16, being an array of multiple individual detectors, can track the position of each of the transmitted beams b, d, and f and hence over time measure these changes in position. For the purposes of this application, the word detector shall be taken to mean a single unit capable of responding to the intensity of light and that an array detector shall mean an aggregate of these individual detectors.

As thermal marker 17 enters the probing region defined by transmitted beams 14 and reflected beams 15 and travels downstream, it will intersect beams b, c, d, e, and f in turn. It will not intersect beam a since this beam has not entered the conduit. Thus for each of the traverses of the beams array detector 16 will monitor the change of position of the beam on the array detector. While array detector 16 is shown monitoring transmitted beams 14, a similar array detector could monitor reflected beams 15 (not shown).

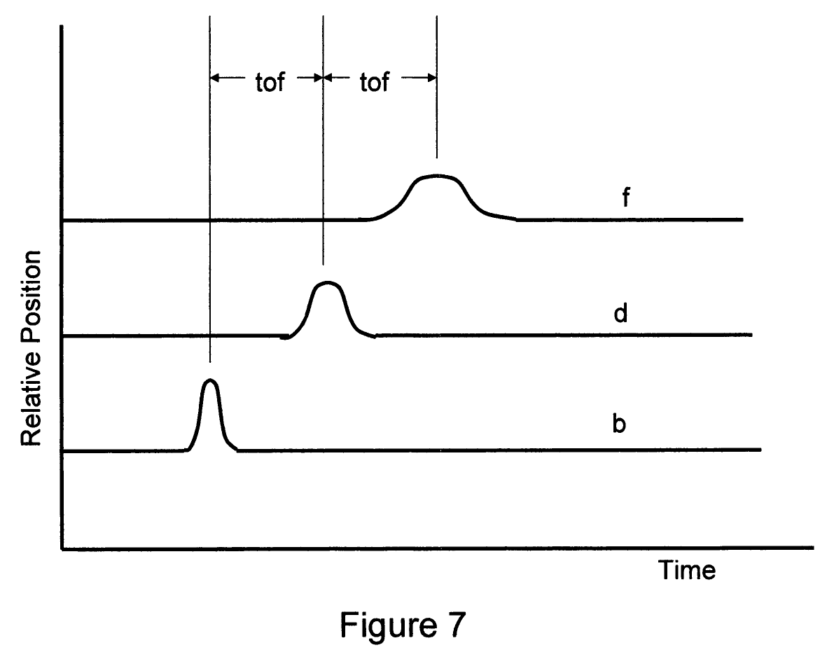

A typical output for detector array 16 is shown in FIG. 7. Since the passage of thermal marker 17 causes a deflection of a beam away from normal, or to the right as shown in FIG. 2, FIG. 7 shows an increase in deflection as an increase in relative position. For the purpose of FIG. 7, it is assumed that a single small thermal marker 17 enters the probing region at a time shown at the origin of the graph. Thermal marker 17 first encounters beam b and as it traverses beam b it causes an increase in relative position that quickly returns to baseline. Thermal marker then moves downstream and traverses beam d, similarly causing an increase in relative position followed by a return to baseline. Subsequently thermal marker 17 traverses beam f causing a similar change in relative position. The time that is required for thermal marker to traverse the distance between beams b and d, and between beams d and f is commonly called the time of flight and is denoted by “tof” in FIG. 7. As shown in FIG. 7, two estimates of “tof” can be calculated and averaged to improve the precision of the estimate. The number of estimates that can be obtained is not limited to two as shown in FIG. 7 but may be more than two if the optical system is designed so as to capture these additional beams. Neutral density filters may be required in order to keep the intensity of the various beams within the acceptable intensity dynamic range of detector array 16. Notice that the pulse representing the change in position of the various beams increases in duration and decreases in amplitude as thermal marker 17 moves downstream. This is due to conduction of the thermal energy in the thermal marker to the surrounding cooler fluid.

Because of the parabolic nature of laminar flow, thermal marker 17 will occupy the center of conduit 11. The separation of beams Z of beams b, d, and f may be calculated from the separation X of beams b, d, and f by detector array 16 in FIG. 1 as
Z=X/Cos θ₁
The velocity of the fluid stream may now be calculated as Z/tof.

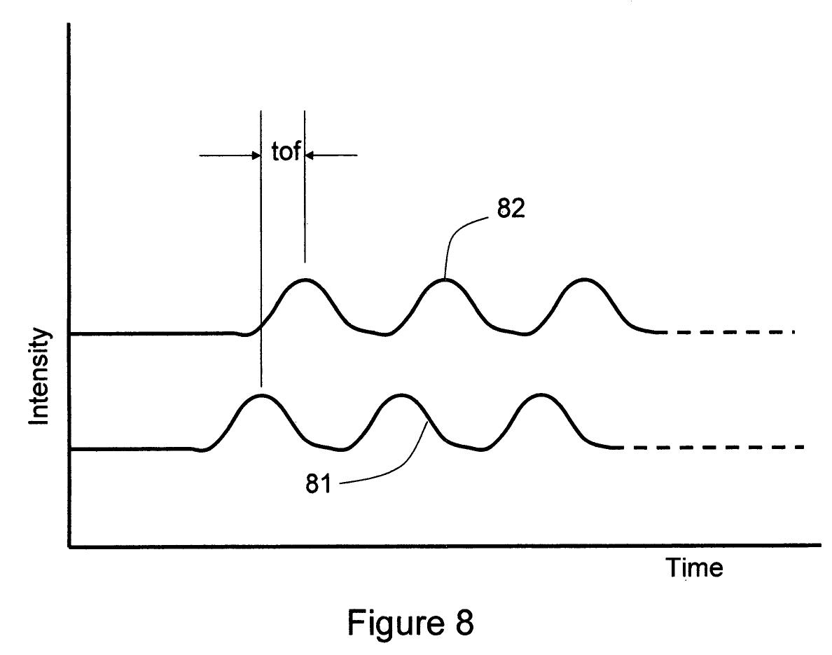

An alternative method for measuring the velocity of the fluid stream is described using FIG. 3. The optical system in the probing region shown in FIG. 3 is identical to the optical system shown in FIGS. 1 and 2. Also shown in FIG. 3 is energy source 19 emitting energy beam 20 to introduce thermal marker 18 into the fluid stream. In this alternative method, a longer in duration thermal marker 18 is introduced into the fluid stream and hence occupies a much larger portion of the probing region and may extend well beyond the probing region. Thermal marker 18 may be modulated such that the temperature of the thermal marker varies with position along conduit 11. This temperature fluctuation is represented by the shading shown in the fluid stream which changes from a lighter to a darker gray. Such a modulated thermal marker may be introduced by varying the output of energy source 19. Modulated thermal marker 18 may be sinusoidal, may be a series of pulses, or any such modulation that provides a periodic temperature profile into the fluid stream. This alternating temperature profile in thermal marker 18 may be detected by detector array 16 or detector array 17 in FIG. 3. Transmitted beams b, d, and f will move across the face of detector array 16. Hence the various detector elements of detector array 16 will receive more or less light depending on the exact position of the transmitted beam as a function of time. This variation in intensity of one of the detector elements of detector array 16 is represented by curve 82 in FIG. 8. Also shown in FIG. 8 is curve 81 which represents the variation in output of energy source 19. When the fluid is moving through the conduit at a constant flow rate, the frequency of detected signal 82 and modulated source 19 as represented by curve 81 will be the same. However, since detector array 16 is downstream of the position where the thermal marker is introduced into the stream, signal 82 is delayed with respect to signal 81. This phase delay is representative of the stream velocity and constitutes a time of flight. Given the distance between the point of introduction of the thermal marker and the position where the transmitted beam passes through the conduit, the velocity of the fluid stream may be calculated as the ratio of the time of flight and the downstream distance to the transmitted beam. In general, the exact position of the location of the transmitted beam is difficult to measure. Hence, to achieve highest accuracy and precision in measuring the fluid velocity using this alternative method, the system should be calibrated using a scale to measure the weight and volume of fluid passing through the system and the phase delay measured at that flow rate.

In a similar manner, a phase delay may be measured using detector array 17 and reflected beams c and e. However, since reflected beam a does not enter the fluid stream, the position of reflected beam a at detector array 17 does not change. The intensity of reflected beam a at detector array 17 does change as the temperature of the fluid changes according to the well known Fresnel reflection law and will also give a signal similar to signal 82 in FIG. 8. Using reflected beam a in this alternative method has two advantages. First, since the position of reflected beam doesn't move, the detector element(s) in detector array 17 to monitor for the signal 82 are known. Second, the distance from the point of introduction of the thermal marker to the point of reflection (location 3 in FIG. 1) is easier to measure.

In general, the probing region generally depicted in FIGS. 1, 2, and 3 is located near the point at which the thermal marker is introduced into the fluid stream. To measure a time of flight caused by the fluid stream carrying the thermal marker through the probing region, the probing region is downstream from the point at which the thermal marker is introduced. To measure a velocity using the thermal dilution method, the point of introduction of the thermal marker may be somewhat closer to the probing region with the point of introduction of the probing light beam slightly upstream, slightly downstream, or two probing regions may be used with one upstream and one downstream. Other than this general requirement, the probing region and heat source may be placed anywhere along the conduit.

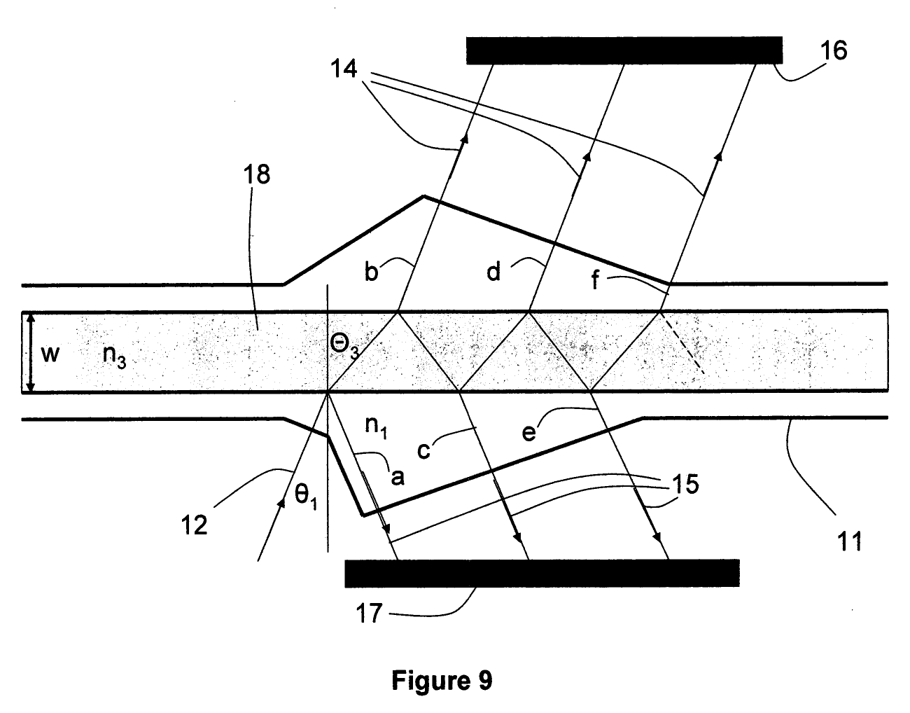

Referring again to FIGS. 1 and 9, the optical system of the invention may be used to measure the refractive index of the fluid flowing in the conduit. Consider FIG. 1 with no fluid in the conduit. Transmitted beams 14 will impinge on detector 16 at certain detector elements determined by methods of signal processing well known in the art. Similarly, reflected beams 15 will impinge on detector 17 in FIG. 3 at certain detector elements. FIG. 9 shows the optical system of the invention with a flowing fluid passing through the probing region and transmitted beams 14 and reflected beams 15. Since the flowing fluid, which may be a liquid, has a refractive index different than the air which was present prior to the presence of the flowing fluid, transmitted beams b, d, and f will be refracted less at the conduit wall fluid interface and hence impinge on detector 16 in different locations. Again by signal processing methods well known in the art, the new locations of transmitted beams b, d, and f can be determined. By geometry and the equations used above, the angular change of refraction at the conduit wall fluid interface can be calculated. By Snell's law, the change in index of refraction can be calculated. With a list of fluids expected to be flowing, the calculated index of refraction can be compared to the index of refraction of expected fluids, and the identity of the fluid identified. For additional precision of the measurement of index of refraction, the temperature of the fluid in the conduit may be measured (not shown). By using the known index of refraction versus temperature for the expected fluids, the accuracy of identifying the fluid can be improved.

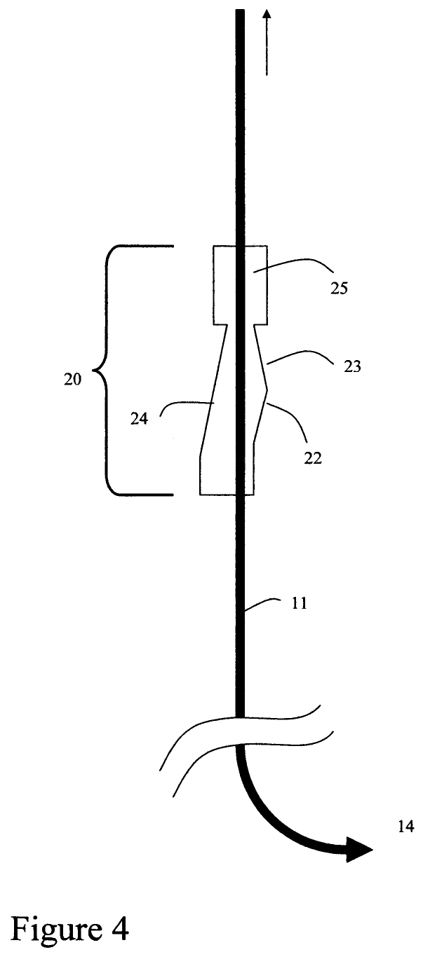

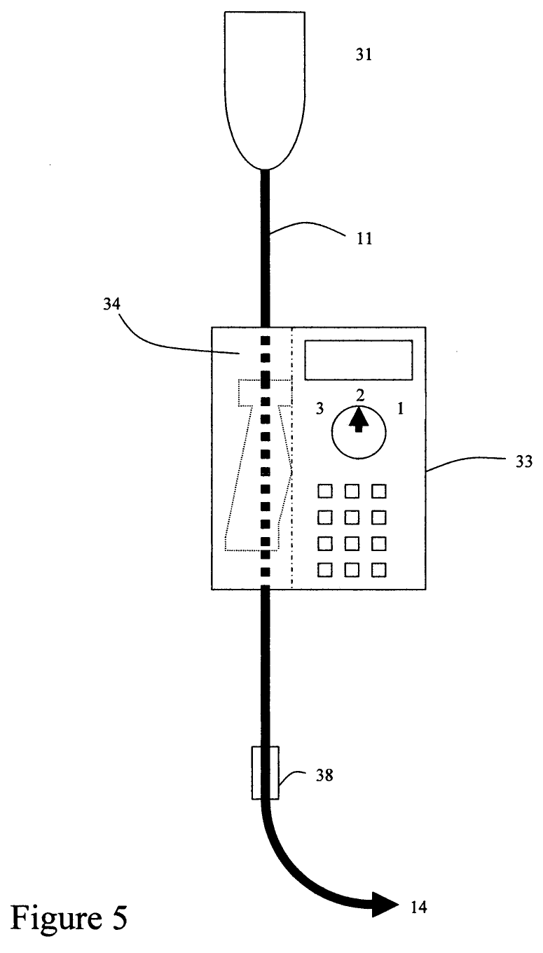

FIG. 4 shows probing region 20 as part of conduit 12. Conduit 11 may be part of an infusion set for intravenous delivery of medication or may be part of an analytical system such as an HPLC system for determining the concentration of different analytes in a specimen. As shown in FIG. 4, probing region 20 is configured as flow cell 25 which is comprised of surface 22 where probing light beam 12 enters the probing region, surface 23 where the reflected beams exit the probing region and surface 24 where the transmitted beams exit the probing region. Flow cell 25 may be made of any material as long as it is not degraded by the fluid passing through the flow cell, the material transmits both the energy to introduce the thermal marker and the probing light source, and the material can be process to provide optically smooth surfaces. Many engineering polymers such as polycarbonate, polypropylene and polyethylene are good candidates. Flow cell 25 as shown in FIG. 4 is also configured so that it is disposable and does not contain any of the active components such as the energy source for introduction of the thermal marker, the source for the probing beam and the detector arrays. Thus flow cell 25 is configured to mate with a reusable unit that does contain the energy source for introduction of the thermal marker, the source for the probing beam and the detector arrays. FIG. 5 shows flow cell 25 as part of conduit 11 which is an infusion set for intravenous delivery of medication. Infusion set 11 is mated to flow controller 33. Door 34 of controller 33 is closed; however, the flow cell may be seen in relief behind the door. To use infusion set 11 with flow controller 33, door 34 would be opened exposing a socket adapted to receive flow cell 25 as shown in FIG. 4. Flow cell 25 would be mated with this socket thereby aligning the various optical components such that the properties of flow may be mentioned as described above.

In operation, especially in a single conduit where the cross sectional area is fixed, the volumetric flow rate is the product of the stream velocity and the cross sectional area. As flow rate is changed, the stream velocity changes in direct proportion to the change in the flow rate. Since stream velocity is the ratio of the time required for a marker to travel a given distance, it is expected that as flow rate changes, the time of flight for the marker to travel the same distance would again be in direct proportion to the change in flow rate. Surprisingly, attempts to demonstrate this linearity are only relatively successful over a relatively short range of flow rates. As the range of flow rates is increased such that the highest flow rate is over a factor of 10 greater than the lowest flow rate, a polynomial relationship between the flow rate and the time of flight is required in order to have a high level of accuracy in predicting a flow rate from a measured time of flight. This need for a polynomial relationship is demonstrated with the following example. A flow sensor of the invention was assembled and tested over a flow rate range of 0.026 microliters per second to 1.076 microliters per second. A pressure cuff was applied to a one liter infusion bag of normal saline so that the driving pressure could be varied. Flow was initiated with a stopcock and the amount of fluid accumulated in a vessel on an electronic scale over a fixed period of time was recorded. During the time period that the fluid was being accumulated, time of flight measurements were made. For each flow episode, 25 time of flight measurements were made, and the mean and standard deviation of these 25 time of flight measurements was calculated. The mean was used to create a calibration curve, the standard deviation was used to determine the precision with which each of the measurements reflected the actual flow rate. These data are tabulated in Table 1 below.

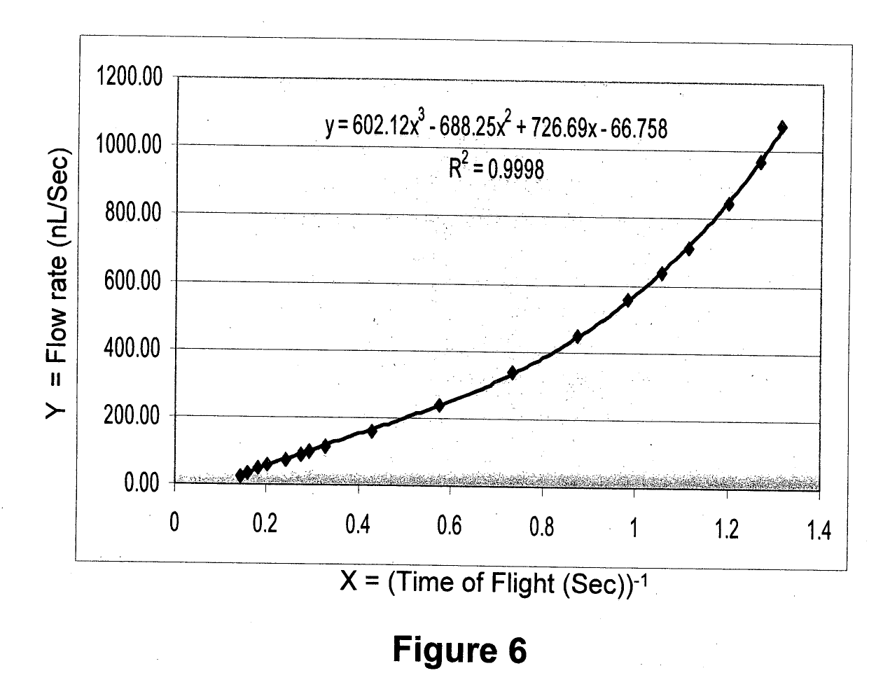

The calibration curve generated from this data is shown in FIG. 6. As can be seen, a linear relationship between time of flight and flow rate would not accurately fit the data. However, a second order polynomial fits the data with surprising accuracy.

TABLE 1

| Flow Rate | AVG TOF | S.D. TOF | CV TOF | |
|---|---|---|---|---|
| (nL/Sec) | (mSec) | (mSec) | (%) | 1/TOF |
| 26.22 | 6.9848 | 0.1034 | 1.48 | 0.143168 |
| 36.28 | 6.2586 | 0.0837 | 1.34 | 0.1597801 |
| 48.46 | 5.5427 | 0.0532 | 0.96 | 0.1804175 |
| 57.72 | 4.9741 | 0.0462 | 0.93 | 0.2010414 |
| 75.86 | 4.1512 | 0.0361 | 0.87 | 0.2408942 |
| 91.38 | 3.6343 | 0.0333 | 0.92 | 0.2751562 |
| 98.67 | 3.437 | 0.0324 | 0.94 | 0.2909514 |
| 114.37 | 3.0588 | 0.0129 | 0.42 | 0.3269256 |
| 159.49 | 2.3428 | 0.0251 | 1.07 | 0.4268397 |
| 239.05 | 1.7411 | 0.0139 | 0.80 | 0.5743495 |
| 339.91 | 1.367 | 0.0089 | 0.65 | 0.7315289 |
| 449.56 | 1.1456 | 0.0018 | 0.16 | 0.872905 |
| 556.33 | 1.0196 | 0.0034 | 0.33 | 0.9807768 |
| 636.69 | 0.948 | 0.0023 | 0.24 | 1.0548523 |
| 710.81 | 0.899 | 0.0024 | 0.26 | 1.1123471 |
| 845.44 | 0.8345 | 0.0029 | 0.35 | 1.1983223 |
| 969.03 | 0.7888 | 0.0031 | 0.39 | 1.2677485 |
| 1076.47 | 0.7616 | 0.0032 | 0.42 | 1.3130252 |

FIG. 9 is a schematic of an optical system of the invention used to measure the refractive index of the fluid flowing in the conduit. The change of index of refraction is represented by the grayish tone of the fluid in FIG. 9 compared to the absence of any tone of the flowing fluid in FIG. 1. The index of refraction of the fluid flowing in the conduit may be measured in two different ways. First, various fluids of known index of refraction may be passed through the probing region and the position of beams transmitted b, d, and f where they are detected by detector array 16 may be recorded for each of the fluids. This forms a calibration curve of position on the array of the various beams versus fluid index of refraction. Being able to determine the position of more than one beam helps improve the precision of the measurement.

Alternatively, the index of refraction of the fluid flowing in the conduit may be determined using reflected beams a, c, and e. Since reflected beam a does not pass through the fluid, its position on detector array 17 in FIG. 9 will not be altered as the refractive index of the fluid changes. However, since reflected beams c and e do pass through the fluid, their positions of detection on detector array 17 will change. Again, fluids of different index of refraction may be passed through the system and the distances of separation of beams a and c and beams a and e may be recorded. This alternative method has the advantage that the measured distance is a difference between two location rather than changes in position which can occur for reasons other than a change in the index of refraction of the fluid.

It is important to recognize that both the fluid flow rate and the fluid refractive index may be determined using the same optical probing system. Such a sensor has utility in systems where both the quantity of fluid moving in the system and the chemical makeup of the fluid are important. Examples of such systems are an HPLC analysis system where two fluids are mixed to provide a density gradient in the conduit and a fuel cell where the amount of fluid flowing to the fuel cell depends on the power required from the flow cell and the efficiency of the fuel cell depends upon the ratio of two or more components of the fuel such as a methanol fuel cell where the ratio of methanol to water is important.

We claim:

1. A fluid delivery system comprising
a) a conduit with a probing region along which fluid may flow from a fluid source to a delivery site,
b) an energy source positioned to introduce a thermal marker into the fluid stream upstream of the probing region,
c) a light source positioned to probe the flowing stream at the probing region such that a series of non-interferometric reflections are created at the fluid conduit interfaces,
d) two or more light sensitive detectors positioned to monitor the reflections, and
f) a processor adapted to receive signals from the detectors corresponding to the intensity of the light at the detectors and to calculate a conduit dimension corresponding to the distance between the reflections and to calculate a deflection of the reflections corresponding to the passage of the thermal marker.

2. A fluid delivery system comprising
a) a conduit with a probing region along which fluid may flow from a fluid source to a delivery site,
b) an energy source positioned to introduce a thermal marker into the fluid stream upstream of the probing region,
c) a light source positioned to probe the flowing stream at the probing region such that a series of non-interferometric reflections are created at the fluid conduit interfaces,
d) two or more light sensitive detectors positioned to monitor the reflections, and
e) a processor adapted to receive signals from the detectors corresponding to the intensity of the light at the detectors and to calculate a deflection of the reflections corresponding to the passage of the thermal marker.

3. The device of claim 1 or claim 2 wherein the two or more detectors comprise a linear array detector system or a two-dimensional array detector system.

4. The device of claim 1 or claim 2 wherein the energy source is an infrared laser.

5. The device of claim 1 or claim 2 wherein the conduit has a rectangular internal cross section.

6. The device of claim 1 or claim 2 wherein the conduit is fabricated to have flat areas at the probing region such that the probing light may enter and exit the interrogation region at normal incidence to the flat areas.

7. The device of claim 1 or claim 2 wherein the thermal marker is sufficiently short in duration that the maximum deflection of the individual beams of the beam pattern occurs at different times.

8. The device of claim 7 wherein a velocity of the stream is calculated using the time difference between the maximum beam deflection of the individual beams of the beam pattern.

9. The device of claim 1 or claim 2 wherein the thermal marker is sufficiently long in duration that the deflections of each of the individual beams of the beam pattern are indistinguishable in time.

10. The device of claim 9 wherein the stream velocity is calculated using the phase difference between the periodicity of the energy source and the periodicity of the deflection of the beam pattern.

11. The device of claims 1 or 2 comprising two separate but matable components wherein one of the components comprises the conduit and the other component comprises the light source.

12. A fluid delivery system comprising
a) a conduit with a probing region along which fluid may flow from a fluid source to a delivery site,
b) an energy source positioned to introduce a thermal marker into the fluid stream upstream of the probing region,
c) a light source positioned to probe the flowing stream at the probing region such that a series of reflections are created at the fluid conduit interfaces,
d) two or more light sensitive detectors positioned to monitor the reflections, and
e) a processor adapted to receive signals from the detectors corresponding to the intensity of the light at the detectors and to calculate a conduit dimension corresponding to the distance between the reflections and to calculate a deflection of the reflections corresponding to the passage of the thermal marker.

13. The device of claim 12 wherein the two or more detectors comprise a linear array detector system or a two-dimensional array detector system.

14. The device of claim 12 wherein the energy source is an infrared laser.

15. The device of claim 12 wherein the conduit has a rectangular internal cross section.

16. The device of claim 12 wherein the conduit is fabricated to have flat areas at the probing region such that the probing light may enter and exit the interrogation region at normal incidence to the flat areas.

17. The device of claim 12 wherein the thermal marker is sufficiently short in duration that the maximum deflection of the individual beams of the beam pattern occurs at different times.

18. The device of claim 17 wherein a velocity of the stream is calculated using the time difference between the maximum beam deflection of the individual beams of the beam pattern.

19. The device of claim 12 wherein the thermal marker is sufficiently long in duration that the deflections of each of the individual beams of the beam pattern arc indistinguishable in time.

20. The device of claim 19 wherein the velocity of the stream is calculated using the phase difference between the periodicity of the energy source and the periodicity of the deflection of the beam pattern.

21. The device of claim 12 comprising two separate but matable components wherein one of the components comprises the conduit and the other component comprises the light source.

22. A method of delivering a fluid comprising the steps of
a) providing a conduit with a probing region along which fluid may flow from a source to a delivery site,
b) providing an energy source positioned to introduce a thermal marker into the fluid stream upstream of the probing region,
c) providing a light source positioned to probe the flowing stream at the probing region such that a series of reflections are created at the fluid conduit interfaces,
d) providing two or more light sensitive detectors positioned to monitor the reflections, and
e) providing a processor adapted to receive signals from the detectors corresponding to the intensity of the light at the detectors and calculating a measurement corresponding to the distance between the reflections and calculating a deflection of the reflections corresponding to the passage of the thermal marker.

23. A method of delivering a fluid comprising the steps of
a) providing a conduit with a probing region along which fluid may flow from a source to a delivery site,
b) providing an energy source positioned to introduce a thermal marker into the fluid stream upstream of the probing region,
c) providing a light source positioned to probe the flowing stream at the probing region such that a series of non-interferometric reflections are created at the fluid conduit interfaces,
d) providing two or more light sensitive detectors positioned to monitor the reflections, and
e) providing a processor adapted to receive signals from the detectors corresponding to the intensity of the light at the detectors and calculating a stream velocity based on the deflection of the reflections corresponding to the passage of the thermal marker.

24. A method of delivering a fluid comprising the steps of
a) providing a conduit with a probing region along which fluid may flow from a source to a delivery site,
b) providing an energy source positioned to introduce a thermal marker into the fluid stream upstream of the probing region,
c) providing a light source positioned to probe the flowing stream at the probing region such that a series of reflections are created at the fluid conduit interfaces,
d) providing two or more light sensitive detectors positioned to monitor the reflections,
e) providing a processor adapted to receive signals from the detectors corresponding to the intensity of the light at the detectors and calculating a time of flight of the thermal marker based on the deflection of the reflections corresponding to the passage of the thermal marker.

25. The method of claim 24 including the step of providing a calibration wherein the result of the calibration is a look-up table where the flow rate is tabulated with the calculated time of flight or a value based on the calculated time of flight.

26. The method of claim 24 including the step of providing a calibration wherein the result of the calibration is a polynomial equation relating the flow rate to the calculated time of flight or a value based on the calculated time of flight.

27. A fluid measuring system comprising
a) a conduit with a probing region filled with fluid,
b) a light source positioned to probe the fluid at the probing region such that a series of non-interferometric reflections are created at the fluid conduit interfaces,
c) two or more light sensitive detectors positioned to monitor the reflections, and
d) a processor adapted to receive signals from the detectors corresponding to the intensity of the light at the detectors and to calculate an index of refraction of the fluid corresponding to the change in position of the reflections compared to the positions determined using a reference fluid.

28. A fluid delivery system comprising
a) a conduit with a probing region along which fluid may flow from a fluid source to a delivery site,
b) an energy source positioned to introduce a thermal marker into the fluid stream upstream of the probing region,
c) a light source positioned to probe the flowing stream at the probing region such that a series of reflections are created at the fluid conduit interfaces,
d) two or more light sensitive detectors positioned to monitor the reflections, and
e) a processor adapted to receive signals from the detectors corresponding to the intensity of the light at the detectors and to calculate a deflection of the reflections corresponding to the passage of the thermal marker and to calculate an index of refraction of the fluid corresponding to the change in position of the reflections compared to the position of the reflections determined for a reference fluid.

29. A fluid delivery system comprising
a) a conduit with a probing region along which fluid may flow from a fluid source to a delivery site,
b) an energy source positioned to introduce a thermal marker into the fluid stream upstream of the probing region,
c) a light source positioned to probe the flowing stream at the probing region such that a series of reflections are created at the fluid conduit interfaces,
d) two or more light sensitive detectors positioned to monitor the reflections, and
e) a processor adapted to receive signals from the detectors corresponding to the intensity of the light at the detectors and to calculate a conduit dimension corresponding to the distance between the reflections, to calculate a deflection of the reflections corresponding to the passage of the thermal marker and to calculate an index of refraction of the fluid corresponding to the change in position of the reflections compared to the position of the reflections determined for a reference fluid.

30. The fluid delivery system of claims 28 or 29 further comprising a temperature sensor physically isolated from the flowing fluid positioned to measure the temperature of the conduit in the probing region.

31. The device of claims 28 or 29 comprising two separate but matable components wherein one of the components comprises the conduit and the other component comprises the light source.

33. A method of identifying the a fluid flowing in a conduit comprising the steps of
a) providing the fluid delivery system of claim 28 or claim 29,
b) determining the index of fraction of a fluid by determining first positions of the reflected beams using a reference fluid and determining second positions of the reflected beams using the fluid and using Snell's law and the separation of the first positions and the second positions.
